(19) United States
(12) Patent Application Publication
(10) Pub. No.: US 2011/0233917 A1
(43) Pub. Date: Sep. 29, 2011

(54) System For Mass Distribution Of Business Cards

(76) Inventor: Alexander Sloot, Sugarloaf, PA (US)

(21) Appl. No.: 12/732,300

(22) Filed: Mar. 26, 2010

(51) Int. Cl. B42D 15/00

(52) U.S. Cl. 283/56

(57) ABSTRACT

A system for distributing business cards including a sheet having a header portion, a body portion, and a tracking code printed thereon, a mailing sleeve having an open end and a closed end and being sized to accommodate the sheet in a folded configuration, and a separable retention pouch formed from the closed end of the mailing sleeve is provided. The body portion of the sheet is divided into at least two business cards, each being separably attached along perforated lines. The header portion of the sheet is sized and/or shaped different from the at least two business cards. Each of the at least two business cards is further divided to include a tab portion, separably attached along perforated lines.

### FIELD OF THE INVENTION

The invention relates to promotional schemes and advertising, in particular, a system for mass distribution of business cards to consumers for promoting sales or the like.

### BACKGROUND OF THE INVENTION

The use of business cards for the exchange of personal or business information is well known in the art. Typically, an individual or business will purchase pre-printed individual business cards that have already been cut apart, or they will purchase sheets of pre-perforated cards and print their personal or business name, contact information, logo or design, etc. on each of the cards. All of the cards on each sheet will have the same image printed thereon. These cards will then be given to others, such as new acquaintances, business partners, potential or current customers, etc., so that they may retain the contact information of the individual or business disseminating the cards. One significant advantage of business cards as a vehicle for the exchange of information is their convenience—they are light and small in size and are shaped to fit in a wallet or small card holder. Moreover, the use of sheets of pre-perforated cards for the creation of individual business cards is also fairly easy and inexpensive. However, the exchange of these business cards as described above generally requires face-to-face contact between the cardholder and the recipient. Therefore, this system is not suitable for increasing public awareness of a business or individual on a large-scale basis.

Wide-spread distribution of individual or business information, or dissemination of messages to customers and/or businesses, can be achieved via large scale distribution of printed advertising sheets as a “ride-along” or “insert” in a newspaper or magazine, or by using direct mail. Mass-mailing to consumers is a well-known way advertise a car or home for sale, a grand opening, or an upcoming sale or event or to disseminate coupons or special offers. In most cases, such coupons or advertisements are printed individually by or on behalf of individual vendors, then gathered and mailed or otherwise distributed in bulk to a broad range of consumers. However, these coupons or advertisements, as they are typically printed individually, will all be on separate sheets of paper, and may be of various sizes and shapes and may be all printed on different materials. The unconnected nature of these coupons makes them sloppy and prone to being lost by the recipient. In addition, the varying sizes of each coupon may be inconvenient for the recipient to carry on his or her person in a wallet or purse. Moreover, the fact that each vendor individually submits its own coupon or advertisement to an administrator may make coordination of the direct-mailing or other distribution program difficult.

### SUMMARY OF THE INVENTION

Accordingly, it is an object of the present invention to provide a low-cost mass distribution system for dissemination of business or individual information, such as advertisements or coupons, in a form that is convenient for recipients to understand, use, carry and save for future use, that also generates additional business for and interest in the individual or business.

These and other objects are achieved by providing a system for distributing business cards comprising a sheet having a header portion and a body portion, a mailing sleeve having an open end and a closed end, said mailing sleeve being sized to accommodate said sheet in a folded configuration, and a retention pouch formed from the closed end of the mailing sleeve, said retention pouch being separable from the mailing sleeve along perforated lines. The retention pouch may be sized to accommodate at least one of said at least two business cards. The sheet, in a folded configuration, may be inserted into the mailing sleeve and the mailing sleeve may then be mass distributed as an insert in a newspaper or a magazine. The body portion of the sheet is divided into at least two business cards, each of the at least two business cards being separably attached along perforated lines. Further, each of the at least two business cards and the header portion have a front surface and a back surface, the front surface of each of the at least two business cards has identification information of a subscribing business printed thereon. The back surface of each of the at least two business cards has additional information of a subscribing business printed thereon. The header portion is different in at least one of size and shape from said at least two business cards.

The system may further comprise at least one self-adhesive magnetic strip. The sheet itself may also be made from a sheet of magnetic paper.

In further embodiments, the identification information of a subscribing business printed on a first of the at least two business cards is different from the identification information of a subscribing business printed on a second of the at least two business cards. The identification information may comprise at least one of: a name of said subscribing business, an address of said subscribing business, a phone number of said subscribing business, a web address of said subscribing business and an email address of said subscribing business.

In still further embodiments, the additional information relating to a subscribing business may be a special offer, said special offer chosen from the group consisting of, a coupon for a free item, a coupon for a percentage discount, and a coupon for a dollar value discount. The additional information relating to a subscribing business may also be a map.

The sheet may also comprise a tracking code printed thereon. The tracking code may be printed on the header portion of the sheet or the tracking code may be printed on at least one of the at least two business cards of the sheet. In other embodiments, the system for distributing business cards comprises a plurality of sheets, the tracking code printed on each of the plurality of sheets being different. The sheet may further comprise at least two tracking codes printed thereon, each of the at least two tracking codes being different.

Other objects of the invention are achieved by providing a system for distributing business cards comprising a sheet having a header portion and a body portion, the body portion being divided into at least two business cards, each of the at least two business cards being separably attached along perforated lines. Each of the at least two business cards and the header portion have a front surface and a back surface, the front surface of each of the at least two business cards has identification information of a subscribing business printed thereon. The back surface of each of the at least two business cards has additional information related to a subscribing business printed thereon. The header portion is different in at least one of size and shape from the at least two business cards. The header portion further includes at least one flap and the body portion further includes at least one slot positioned to receive the at least one flap when the sheet is in a folded configuration. When said sheet is in a folded configuration, the at least one flap may be inserted into the at least one slot and the sheet may then be mass distributed as an insert in a newspaper or a magazine. In further embodiments, the sheet comprises a tracking code printed thereon.

Still other objects of the invention are achieved by providing a system for distributing business cards comprising a sheet having a header portion and a body portion, the body portion being divided into at least two business cards, each of the at least two business cards being separably attached along perforated lines. Each of the at least two business cards and the header portion have a front surface and a back surface, the front surface of each of the at least two business cards has identification information of a subscribing business printed thereon. The back surface of each of the at least two business cards has additional information relating to a subscribing business printed thereon, the identification information of a subscribing business printed on a first of the at least two business cards is different from the identification information of a subscribing business printed on a second of the at least two business cards. The header portion is different in at least one of size and shape from the at least two business cards. The sheet further has a tracking code printed thereon.

Other objects of the invention are achieved by providing a system for distributing business cards comprising a sheet having a header portion and a body portion, the body portion being divided into at least two business cards, each of the at least two business cards being separably attached along perforated lines. Each of the at least two business cards and the header portion have a front surface and a back surface, the front surface of each of the at least two business cards has the identification information of a subscribing business printed thereon. The back surface of each of the at least two business cards has the additional information of a subscribing business printed thereon. The identification information of a subscribing business printed on a first of the at least two business cards is different from the identification information of a subscribing business printed on a second of the at least two business cards. The header portion is different in at least one of size and shape from the at least two business cards.

Each of said at least two business cards is further divided to include a tab portion, separably attached along perforated lines. The tab portion may include a space for providing contact information of a recipient, which may include the name of a recipient, an address of a recipient, a phone number of a recipient or an email address of a recipient. The tab may also have a tracking code printed thereon.

### BRIEF DESCRIPTION OF THE DRAWINGS

FIG. 1 is a front view of one embodiment of a sheet for use in the system of the present invention.

FIG. 2 is a back view of one embodiment of a sheet for use in the system of the present invention.

FIG. 3 is a front view of one embodiment of a sheet for use in the system of the present invention.

FIG. 4 is a front view of one embodiment of a sheet of self-adhesive magnets for use in the system of the present invention.

FIG. 5 is a back view of one embodiment of a business card with a self-adhesive magnet disposed thereon for use in the system of the present invention.

FIG. 6 is a front perspective view of one embodiment of a mailing sleeve for use in the system of the present invention.

FIG. 7 is a back perspective view of one embodiment of a mailing sleeve for use in the system of the present invention.

FIG. 8 is a front view of one embodiment of a retention pouch for use in the system of the present invention.

FIG. 9 is a back view of one embodiment of a retention pouch with self-adhesive magnets disposed thereon for use in the system of the present invention.

FIG. 10 is a front view of a sheet for use in the system of the present invention.

FIG. 11 is a view of one embodiment of a sheet in a folded configuration for use in the system of the present invention.

### DETAILED DESCRIPTION OF THE INVENTION

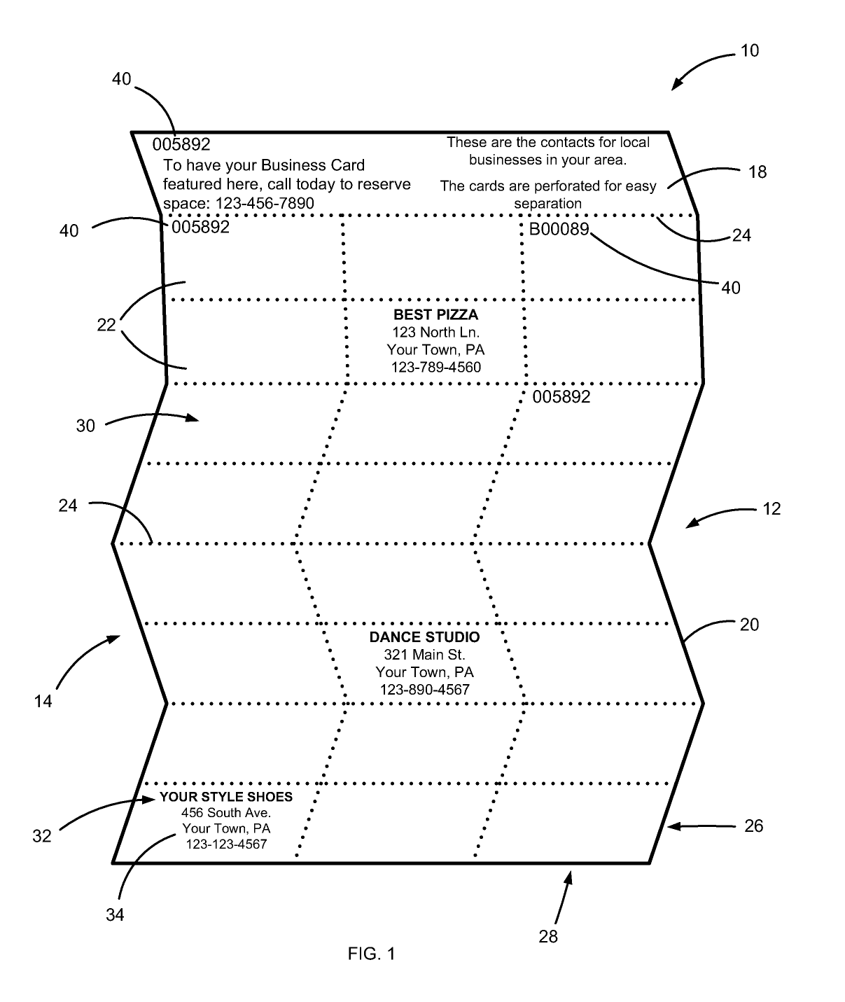

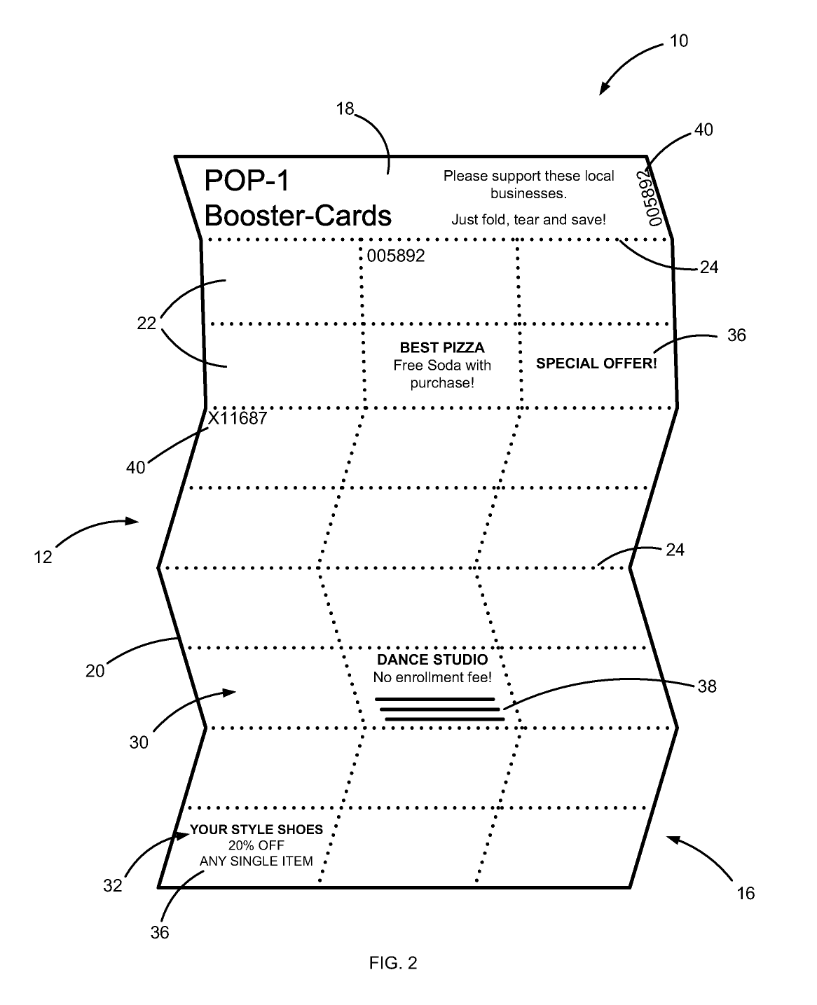

Referring now to FIG. 1, one embodiment of a system 10 for distributing business cards is shown. The system 10 includes a sheet 12, having a front surface 14 (shown in FIG. 1) and a back surface 16 (shown in FIG. 2), that is divided into a header portion 18 and a body portion 20. The sheet 12 may be made of any suitable type of stationary, preferably a durable material such as paper-board or cardstock. The sheet 12 may come in any size and may be customized to tailor to the needs of the distribution or direct-mailing program. In one embodiment, the sheet measures thirteen inches by nineteen inches. In another embodiment, the sheet 12 measures ten and one half (10.5) inches by eighteen and three-quarters (18.75) inches.

The body portion 20 of the sheet 12 is further divided into at least two business cards 22. Each business card 22 is separable from the sheet 12 along perforated lines 24 which define the border between adjacent business cards 22 and the header portion 18. The perforated lines 24 may be micro-perforated, slot-cut slot-perforated, or die-cut. In the present embodiment, the body portion 20 is divided into a certain number of rows 26 and columns 28, defining a number of identically shaped and sized business cards 22. The business cards 22 may each be the size and shape of a traditional business card—a three and a half (3.5) inch by two (2) inch rectangle. In another embodiment, a 13″×19″ sheet 12 is divided into twenty-four (24) 3.5″×2″ business cards 22. In another embodiment, a 21″×18″ sheet 12 is divided into forty-eight (48) 3.5″×2″ business cards 22. However, the present disclosure contemplates that the cards 22 may be of any size and/or shape and that some of the cards may be of a different size and/or shape than some of the others. So as not to waste any space on the sheet 12, preferably, the business cards 22, are sized and shaped to fill the entire body portion 20. Alternatively, the business cards 22 may be die-cut into a particular shape, such as a house or a car, corresponding to the type of information or advertisement printed thereon, as will be described further below.

An advertising space 30 is defined by each one of the business cards 22, and includes both the front 14 and back 16 surface of each card. These advertising spaces 30 may be sold to any number of subscribing businesses 32, i.e., each subscribing business pays an administrator of the business card mass distribution program to be featured on the sheet 12. Thus, the mass distribution system 10 may be used to generate money for the administrator of the program. It is understood that the term “business” is not limited to any formal type of organizational structure and may include individuals. Thus, a subscribing business 32 may be any entity, such as a restaurant, retail store, auto shop, real estate agent, lawyer, plumber or an individual looking to sell a particular item such as a car, home, etc. Preferably, each advertising space 30 would feature a different subscribing business 32.

The front surface 14 of each business card 22 may therefore have printed thereon identification information 34 of the corresponding subscribing business 32. This identification information 34 may include the name of the business or individual, street address, phone number, web address and/or email address. Turning to FIG. 2, the back surface 16 of each business card 22 may have some additional information 36 of the subscribing business 32 printed thereon. This additional information 36 may include a general message, a map of the location of the subscribing business, further information about an item for sale, a design or logo, information about a sale or grand opening, or a special offer such as a coupon for a free item, a percentage discount, a dollar value discount, a free gift, a gift certificate or a gift card. Thus, these business cards 22 may serve to generate business or secure sale of an item by enticing the recipient of the sheet to visit or contact the subscribing business (in person or via the Internet).

The system for mass distribution of business cards 10 may also be used by the subscribing businesses 32 to gather information from recipients of the sheet 12 who happen to visit or contact that subscribing business 32. The back surface 16 of each business card 22 may also include a space 38 for a recipient's contact information, which may include name, address, phone number, and/or email address. Upon visiting the subscribing business 32, the recipient would fill in his or her contact information in the space 38 and leave the card 22 with the subscribing business. This information may be used by the subscribing business 32 to build its mailing list/email list so that it may notify customers of sales or promotions or to send additional coupons in the future. This gives the subscribing business 32 the opportunity to turn recipients of the sheet 12 into returning customers, allowing for even more potential sales. Moreover, having a space 38 for the recipient to place his or her contact information makes it easy for a subscribing business 32 to use the cards 22 as prize-drawing entries.

The header portion 18 is different in at least size or shape from the at least two business cards 22. For example, as shown in FIG. 1, the header portion 18 is the length of three business cards 22, and is approximately the height of one row 26 of business cards 22. However, the header portion may be the length of only two business cards and the height of one or two rows 26. Alternatively, the header portion may be the length of only one business card 22 and the height of two rows 26. It is understood that any space not taken up by the header portion 18 may be divided into additional business cards 22. The header portion 18 may have a straight-edge finish, or it may be die-cut into a shape. The shape can conform to a logo or design.

The header portion may have printed thereon the name and contact information of the administrator of the business card mass distribution program so that other interested businesses or individuals may purchase an advertising space 30 in the future. For example, if the sheets of business cards are to be mass distributed in a newspaper or magazine, the header portion 18 could be customized with the name of the magazine or newspaper in which the sheets are to be distributed. In addition, the header portion may include instructions for how to use the business cards 22 or information regarding the numbering of the cards and/or header. In addition, the header portion 18 may feature the name of an advertiser or sponsor of the mass distribution program.

The sheet 12 may also have one or more tracking codes 40 printed thereon. The tracking codes 40 may be a sequence of numbers or letters, an alpha-numeric code, a code-word, a bar-code or the like. The tracking code 40 may be printed on the front 14 and/or back 16 surface of either the header portion 18, the business cards 22 or both the header portion 18 and the business cards 22. Moreover, only some of the business cards 22 on the sheet may be printed with a tracking code 40, depending on the desires of the individual subscribing business. As will be described further below, according to the system 10 of the present invention, a sheet 12, containing the business cards 22 of a plurality of subscribing businesses, is mailed out or otherwise distributed to any number of intended recipients. Preferably, each of the distributed sheets 12 is printed with consecutive tracking codes 40. Thus, each sheet 12 would have a unique tracking code 40, with the code 40 changing on successive sheets.

Alternatively, the tracking code 40 may be different on the same sheet 12 of cards. The tracking code 40 may be printed on some or all of the business cards 22 on the sheet 12, depending on the preference of the subscribing business. Moreover, the tracking code 40 itself may be chosen at the discretion of the subscribing business 32 and, thus, a different tracking code 40 may be printed on the business cards 22 of each of the participating subscribing businesses 32. In addition, a different tracking code 40 may be printed on each surface of the business card 22. All possible combinations and iterations of the numbering schemes outlined above are contemplated.

In the case where the same tracking code 40 is printed on each individual sheet 12, with the code changing on successive sheets, the tracking code 40 would therefore function as a way of identifying each recipient of a sheet. This may be utilized by the administrator of the mass distribution program and/or the subscribing businesses in several different ways. For example, when a recipient of a sheet 12 visits or contacts a subscribing business 32, the recipient may register with the subscribing business 32 and the subscribing business 32 may take note of that recipient's tracking code 40 on a special form (not shown) provided by the administrator of the mass distribution program. The administrator of the mass distribution program may provide a deadline for the sheet recipients to register with the subscribing businesses. After the deadline is over, the subscribing businesses 32 return the special form to the administrator who then compiles all of the data to determine which sheet recipients visited which of the subscribing businesses. This is a useful way for the subscribing business and/or program administrator to track the number of sheet recipients that actually visited or contacted them, allowing the subscribing business to gauge the value of purchasing the advertising space 30. Moreover, it may allow the administrator of the mass distribution program to evaluate the geographic area for which sheets 12 were sent, etc. In addition, the tracking code 40 may also be used for contests or prize drawings facilitated by either the subscribing businesses 32 or the program administrator. For example, the administrator may give prizes or prize drawing entries to those recipients who register with the most subscribing businesses.

In addition to being used by the program administrator, the tracking code(s) 40 may be used by the participating subscribing businesses 32 to encourage recipients of the cards to visit their businesses and make purchases. For example, the subscribing business may use the tracking code for promotions, prize drawings and the like. As mentioned above, the subscribing business 32 may use the cards 22 as prize-drawing entries. When a recipient visits a subscribing business 32, the recipient may note his/her contact information on the space provided on the card 22 and place it in the drawing or raffle.

As another means for encouraging recipients to visit the subscribing businesses 32, the tracking code 40 may be used to implement a “lucky-number” program. The lucky number program may be implemented as a “no-purchase necessary” program. The participating subscribing businesses 32 can feature one or more “lucky” numbers or codes on a poster or sign within their business and/or on their business's website. If the recipient's tracking code 40 matches the lucky number or code featured by the subscribing business, he or she could win a prize. If the tracking code 40 is a bar code, the bar code on the recipient's card 22 may be scanned upon visiting a subscribing business.

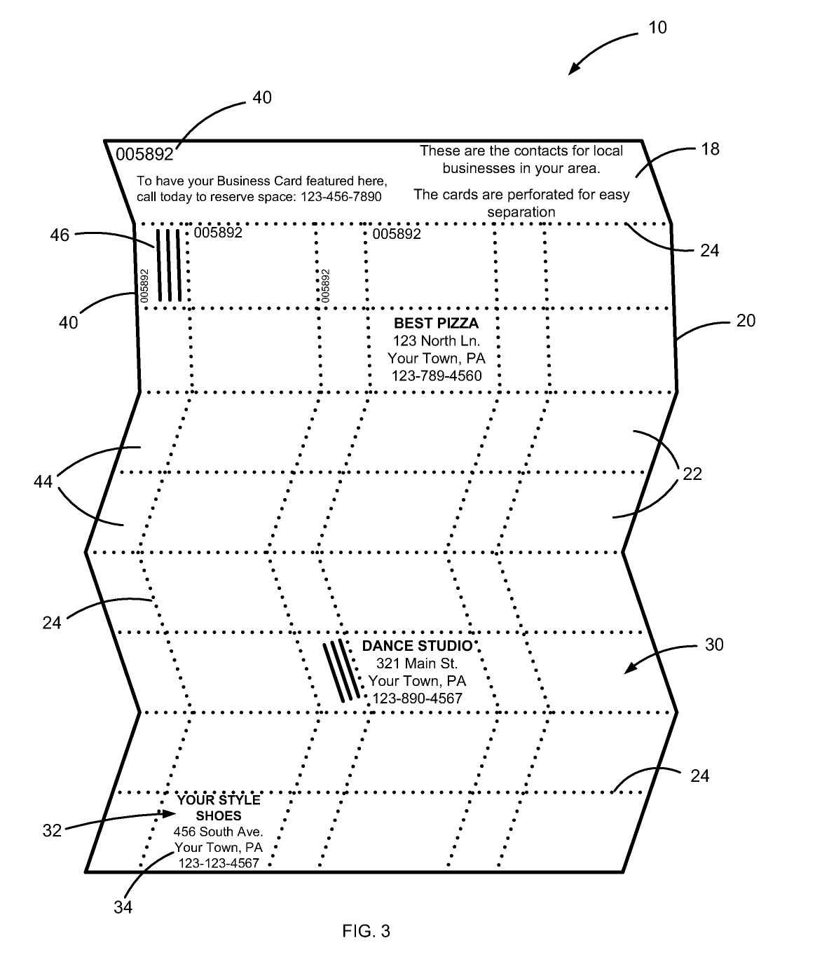

Turning to FIG. 3, another embodiment of the sheet 12 of the present invention is shown. Each of the at least two business cards 22 are further divided by perforated lines 24 to include a tab portion 44. The tab portion 44 may include a space 46 for the recipient to put his/her contact information. This allows the recipient to register with a subscribing business 32 by simply completing the space 46, tearing off the tab portion 44 of the business card 22 and leaving it with the subscribing business. Space 46 on the tab portion 44 is an added convenience over the space 38 on the business card itself because the recipient need not leave the entire card with the subscribing business, but rather can retain it for future reference. In addition, the tab portion 44 may also include a tracking code 40. Again, numbering the tab portion 44 provides the added benefit of the recipient being able to simply remove the tab portion 44 and leave it with a subscribing business. The subscribing business may then, for example, use the tab portion 44 like a raffle ticket for entering the recipient in a prize drawing.

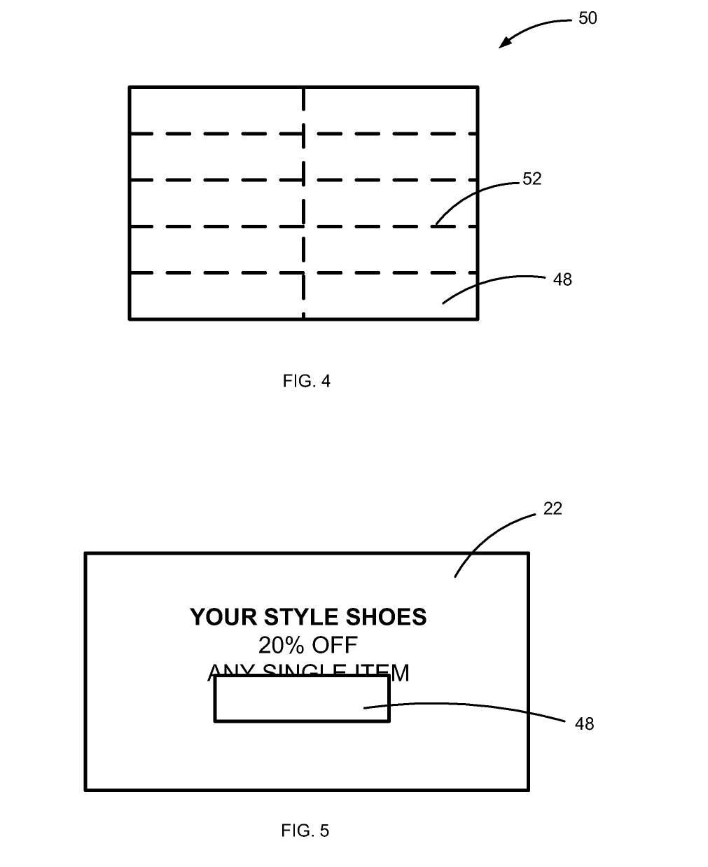

The system for distributing business cards 10 may also include at least one self-adhesive magnet strip 48. Any number of magnet strips 48 may be included in the system 10. The magnetic strips 48 may be provided individually, or for example, as shown in FIG. 4, the magnet strips 48 may come in a set 50, where each magnet 48 is separably attached along perforated or scored lines 52. As shown in FIG. 5, one or more individual magnet strips 48 may be removed from the set 50, the backing (not shown) peeled away and adhered to a business card 22 so that it may be displayed on a metallic surface, such as a refrigerator. This is a way for the recipient of the sheet 12 of business cards 22 to retain the cards of his or her favorite or most frequented subscribing businesses while keeping the contact information close at hand. Alternatively, the system 10 may be provided with one or more double-sided adhesive strips, or the entire sheet 12 may be made of flexible magnetic material or magnetic paper.

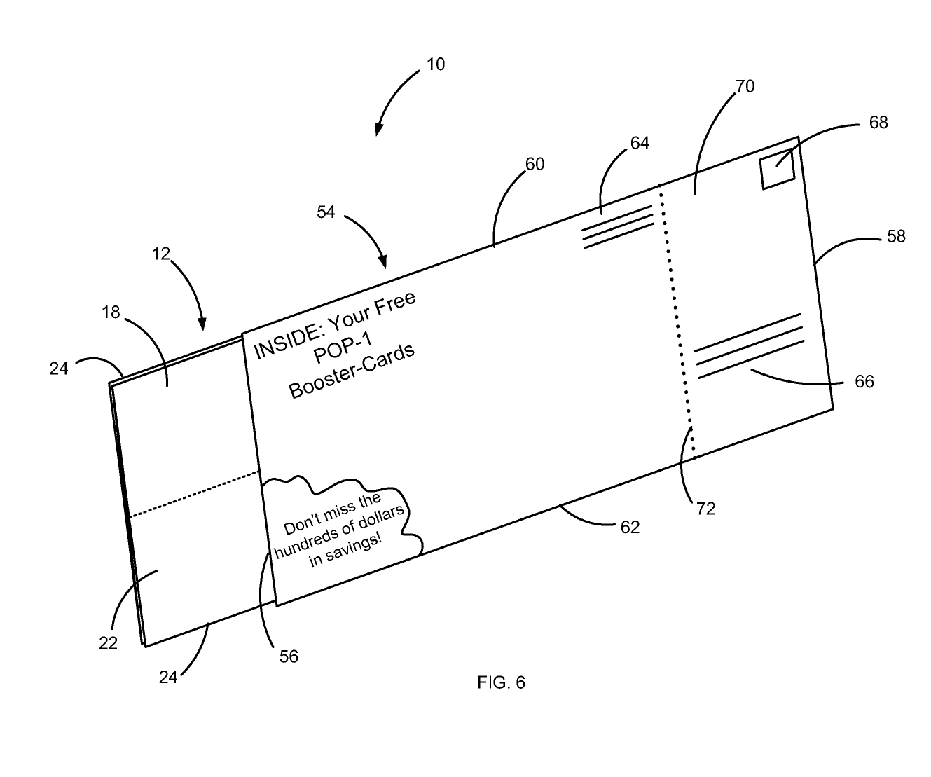

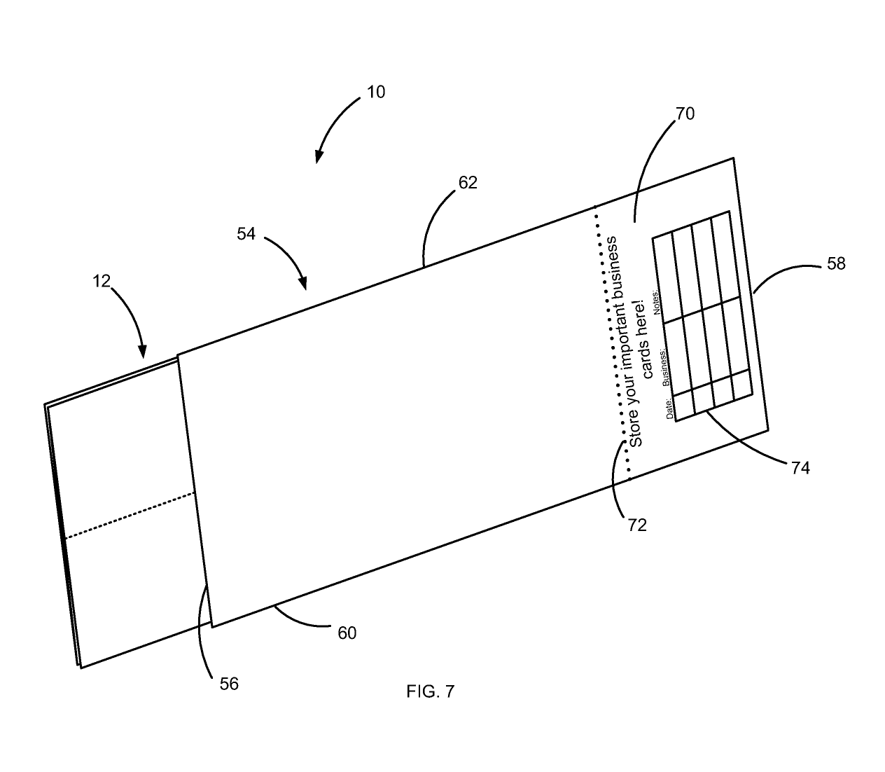

As shown in FIGS. 6 and 7, the system for distributing business cards 10 may also include a mailing sleeve 54. The mailing sleeve has an open end 56 and a closed end 58. Preferably, at least one of the sides 60, 62 of the sleeve 54 is also closed. Either side of the sleeve 54 may include a space for providing the mailing address of the sender 64 (typically the program administrator or publisher), a space for providing the mailing address of the intended recipient 66, a space for postage 68. However, if the business cards are to be distributed as a “ride-along” in a newspaper or magazine, as will be described further below, the mailing sleeve 54 need not provide a place for mailing addresses and/or postage. The name of the program administrator, informational messages about the program or logos/designs may also be printed on the sleeve 54. The mailing sleeve 54 is sized to fit the sheet 12 of business cards in some folded configuration. Thus, the size of the mailing sleeve 54 will depend in part on the size of the sheet 12. The sheet 12 may be folded in any manner, but, preferably, the sheet 12 is folded along the perforated lines 24.

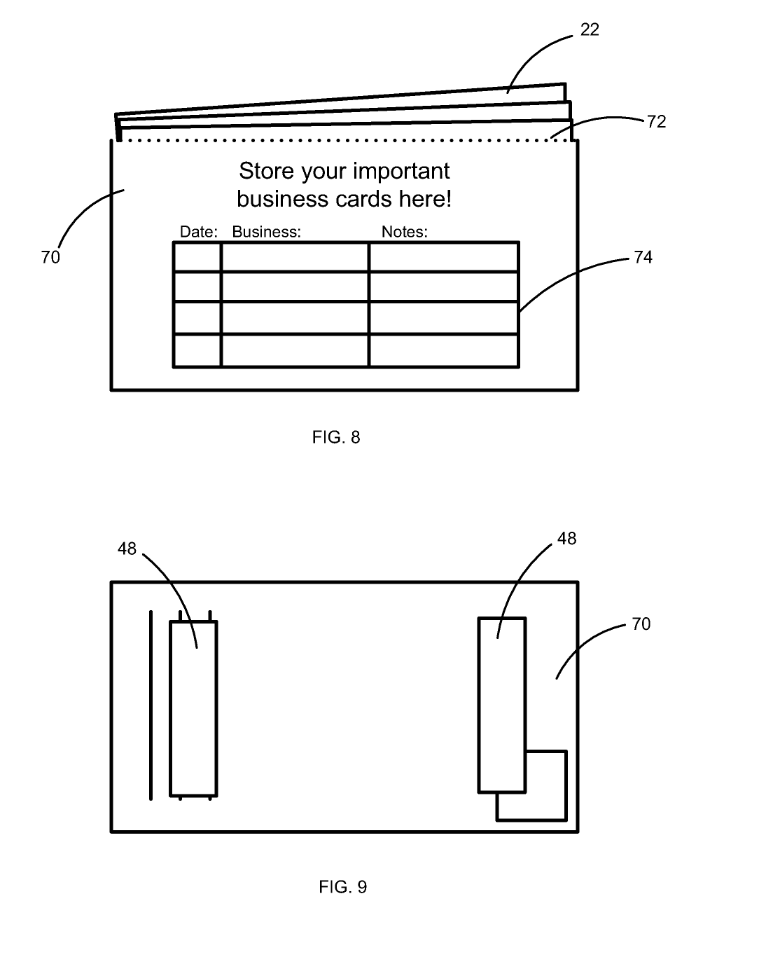

In addition, closed end 58 of the sleeve 54 may also form a retention pouch 70. The pouch 70 is separable from the remainder of the mailing sleeve 54 along perforated lines 72. As shown in FIG. 8, the pouch 70 is preferably sized and shaped to accommodate at least one business card 22 therein. Thus, a recipient may store the business cards 22 of his or her favorite subscribing businesses in the pouch. Because the retention pouch 70 is preferably along the same size of a business card 22, it may be easily carried in one's pocket, wallet or handbag or may be stored in the recipient's car. This is not only a convenient way for a recipient to store those business cards he/she chooses to save, but it also provides some protection from damage to the cards and prevents them from being lost or discarded. The pouch 70 may include a space 74 for the recipient to mark down when he/she visited or contacted a subscribing business and to add some notations about that subscribing business. Moreover, the recipient may choose to place one or more self adhesive magnets 48 on the pouch itself and display it on a magnetic surface, rather than placing magnets on the business cards 22 themselves. This allows the recipient to keep the business cards 22 in a convenient location, such as on the refrigerator, even though he/she may not wish to adhere a magnet directly on the cards.

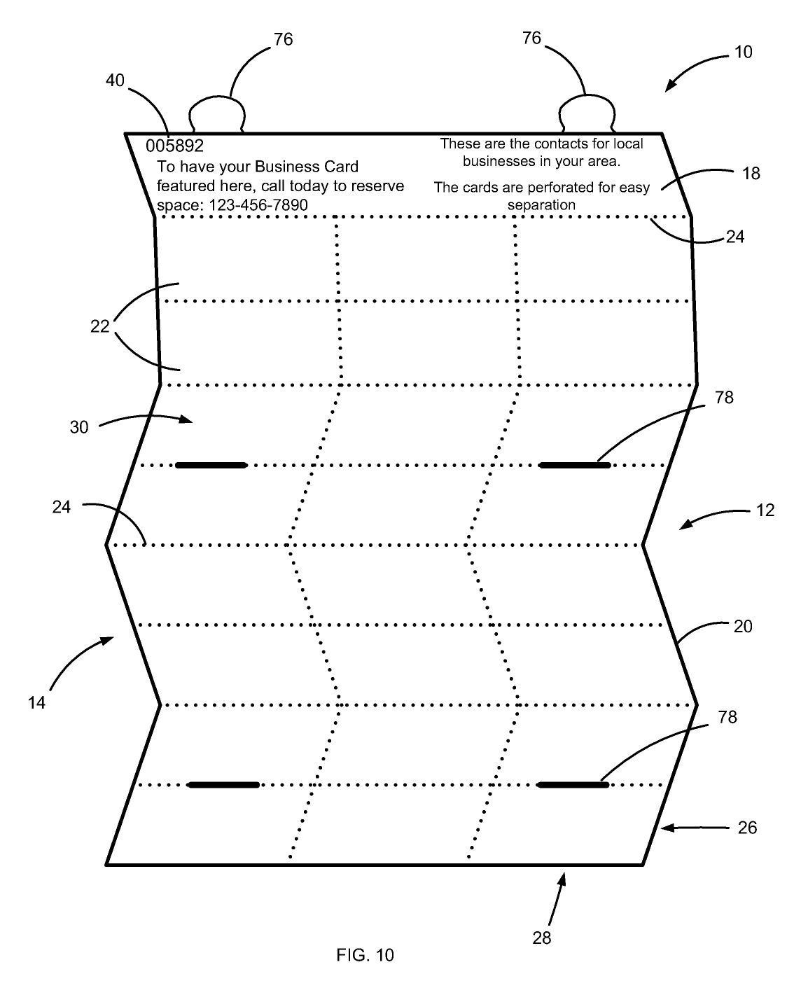

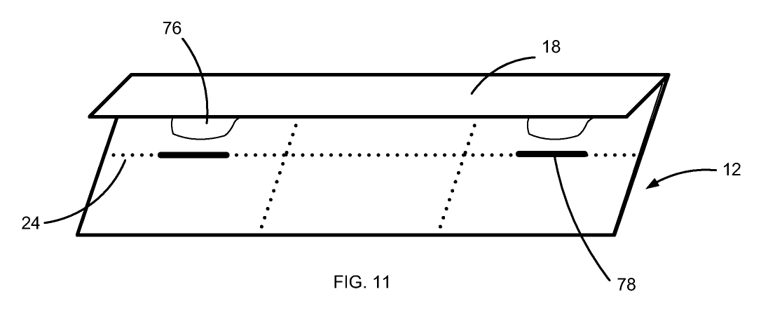

As shown in FIGS. 10 and 11, the system for distributing business cards 10 may be secured in a folded configuration by means of a flap and slot system. The header portion 18 of a sheet 12 may be provided with one or more flaps 76. These flaps 76 are provided to mate with one or more slots 78 provided on the body portion 20 of a sheet 12. The slots 78 may be provided along one or more of the perforated lines 24. The position of the slots 78 governs whether the sheet may be folded in half, or in quarters (FIG. 11). This system allows the sheet 12 to be “locked closed” by inserting the flap(s) 76 into corresponding slots 78 and is a convenient way to keep the sheets 12 folded closed when they are inserted into a newspaper or magazine for mass distribution. In order to facilitate easier folding of the sheet 12, the row of cards closest to the header portion may be sized slightly larger than the other rows of cards. Alternatively, the header portion 18 may simply be folded down and held into place with a self-sticking wafer seal.

In operation, the system for distributing business cards 10, including the sheet 12, is distributed to some group of intended recipients. This group of intended recipients may include individuals living in some geographic area, such as a metropolitan area, a county, or a particular zip code. It may include some group of individuals of a particular demographic or age. It may include only residential addresses, or business addresses, or both. Alternatively, the group of intended recipients may include individuals subscribing to a particular magazine or newspaper. Typically, the group will include a large number of intended recipients, for example, 20,000 households. These variables will be chosen by the mass distribution program administrator, taking into consideration the particular subscribing businesses that have purchased an advertizing space 30 on the sheet 12. For example, the program administrator may organize a sheet 12 with local businesses within a particular geographic area and will therefore choose the group of intended recipients from that same geographic area. Or, if the subscribing businesses 32 on a sheet 12 are relevant to young adults or children, then the group of intended recipients may be chosen from households with children. Alternatively, a commercial bank may organize a business card mass distribution program featuring its commercial customers in the advertising spaces 30 as a means for improving their businesses.

The system for distributing businesses cards 10 may be disseminated to the group of intended recipients in many different ways. The sheets 12 may be inserted in a plain mailing envelope (not shown), a clear mailing poly-bag (not shown) or the mailing sleeve 54 and mailed as is, or may be inserted in an envelope or the mailing sleeve 54, and mailed or distributed by inserting it inside a newspaper or a magazine. In the latter case, the sheets 12 need not necessarily be inserted into the envelope or mailing sleeve 54, but may simply be inserted as a “ride-along” in the publication either folded along one or more of the perforated lines 24 or simply left as an unfolded sheet. Or, the sheet 12 may be secured in a folded position with a wafer-seal or the flap and slot system described above. Also, the system 10 may be included as a “ride-along” to any other type of mass mailing, such as bank statements, etc. The system 10 may be distributed to the group of intended recipients bi-monthly, thrice annually, or as frequently as the program administrator so chooses.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A system for distributing business cards comprising:
a sheet having a header portion and a body portion;
a mailing sleeve having an open end and a closed end, said mailing sleeve being sized to accommodate said sheet in a folded configuration; and
a retention pouch formed from the closed end of the mailing sleeve, said retention pouch being separable from a remaining portion of the mailing sleeve along perforated lines;
said body portion being divided into at least two business cards, each of said at least two business cards being separably attached along perforated lines;
each of said at least two business cards and said header portion having a front surface and a back surface, the front surface of each of said at least two business cards having identification information of a subscribing business printed thereon, the back surface of each of said at least two business cards having additional information of a subscribing business printed thereon;
said header portion being different in at least one of size and shape from said at least two business cards.

2. The system for distributing business cards of claim 1 wherein the identification information of a subscribing business printed on a first of said at least two business cards is different from the identification information of a subscribing business printed on a second of said at least two business cards.

3. The system for distributing business cards of claim 1 wherein said retention pouch is sized to accommodate at least one of said at least two business cards.

4. The system for distributing business cards of claim 1 wherein said additional information relating to a subscribing business is a special offer, said special offer chosen from the group consisting of, a coupon for a free item, a coupon for a percentage discount, and a coupon for a dollar value discount.

5. The system for distributing business cards of claim 1 wherein said additional information relating to a subscribing business is a map.

6. The system for distributing business cards of claim 1 wherein said identification information comprises at least one of: a name of said subscribing business, an address of said subscribing business, a phone number of said subscribing business, a web address of said subscribing business and an email address of said subscribing business.

7. The system for distributing business cards of claim 1 further comprising at least one self-adhesive magnetic strip.

8. The system for distributing business cards of claim 1 wherein said sheet is made from a sheet of magnetic paper.

9. The system for distributing business cards of claim 1 wherein said sheet further comprises a tracking code printed thereon.

10. The system for distributing business cards of claim 9 wherein the tracking code is printed on the header portion of said sheet.

11. The system for distributing business cards of claim 10 wherein the tracking code is printed on at least one of said at least two business cards of said sheet.

12. The system for distributing business cards of claim 9 wherein the tracking code is printed on at least one of said at least two business cards of said sheet.

13. The system for distributing business cards of claim 9 further comprising a plurality of sheets, the tracking code printed on each of said plurality of sheets being different.

14. The system for distributing business cards of claim 1 wherein said sheet further comprises at least two tracking codes printed thereon, each of said at least two tracking codes being different.

15. The system for distributing business cards of claim 1 wherein said sheet, in a folded configuration, is inserted into said mailing sleeve and wherein said mailing sleeve is mass distributed as an insert in a newspaper or a magazine.

16. A system for distributing business cards comprising:
a sheet having a header portion and a body portion;
said body portion being divided into at least two business cards, each of said at least two business cards being separably attached along perforated lines;
each of said at least two business cards and said header portion having a front surface and a back surface, the front surface of each of said at least two business cards having identification information of a subscribing business printed thereon, the back surface of each of said at least two business cards having additional information related to a subscribing business printed thereon;
said header portion being different in at least one of size and shape from said at least two business cards;
said header portion further including at least one flap and said body portion further including at least one slot positioned to receive said at least one flap when said sheet is in a folded configuration.

17. The system for distributing business cards of claim 16 wherein the identification information of a subscribing business printed on a first of said at least two business cards is different from the identification information of a subscribing business printed on a second of said at least two business cards.

18. The system for distributing business cards of claim 16 wherein said sheet further comprises a tracking code printed thereon.

19. The system for distributing business cards of claim 18 wherein the tracking code is printed on the header portion of said sheet.

20. The system for distributing business cards of claim 19 wherein the tracking code is printed on at least one of said at least two business cards of said sheet.

21. The system for distributing business cards of claim 18 wherein the tracking code is printed on at least one of said at least two business cards of said sheet.

22. The system for distributing business cards of claim 18 further comprising a plurality of sheets, the tracking code printed on each of said plurality of sheets being different.

23. The system for distributing business cards of claim 18 wherein said sheet further comprises at least two tracking codes printed thereon, each of said at least two tracking codes being different.

24. The system for distributing business cards of claim 16 wherein said at least one flap, when said sheet is in a folded configuration, is inserted into said at least one slot and wherein said sheet is mass distributed as an insert in a newspaper or a magazine.

25. A system for distributing business cards comprising:
a sheet having a header portion and a body portion;
said body portion being divided into at least two business cards, each of said at least two business cards being separably attached along perforated lines;
each of said at least two business cards and said header portion having a front surface and a back surface, the front surface of each of said at least two business cards having identification information of a subscribing business printed thereon, the back surface of each of said at least two business cards having additional information relating to a subscribing business printed thereon;
the identification information of a subscribing business printed on a first of said at least two business cards being different from the identification information of a subscribing business printed on a second of said at least two business cards;
said header portion being different in at least one of size and shape from said at least two business cards;
said sheet having a tracking code printed thereon.

26. The system for distributing business cards of claim 25 wherein the tracking code is printed on the header portion of said sheet.

27. The system for distributing business cards of claim 26 wherein the tracking code is printed on at least one of said at least two business cards of said sheet.

28. The system for distributing business cards of claim 25 wherein the tracking code is printed on at least one of said at least two business cards of said sheet.

29. The system for distributing business cards of claim 25 wherein said additional information relating to a subscribing business is a special offer, said special offer chosen from the group consisting of, a coupon for a free item, a coupon for a percentage discount, and a coupon for a dollar value discount.

30. The system for distributing business cards of claim 25 wherein said additional information relating to a subscribing business is a map.

31. The system for distributing business cards of claim 25 wherein said identification information is chosen from the group consisting of: a name of said subscribing business, an address of said subscribing business, a phone number of said subscribing business, a web address of said subscribing business and an email address of said subscribing business.

32. The system for distributing business cards of claim 25 further comprising at least one self-adhesive magnetic strip.

33. A system for distributing business cards comprising:
a sheet having a header portion and a body portion;
said body portion being divided into at least two business cards, each of said at least two business cards being separably attached along perforated lines;
each of said at least two business cards and said header portion having a front surface and a back surface, the front surface of each of said at least two business cards having identification information of a subscribing business printed thereon, the back surface of each of said at least two business cards having additional information of a subscribing business printed thereon;
the identification information of a subscribing business printed on a first of said at least two business cards being different from the identification information of a subscribing business printed on a second of said at least two business cards;
said header portion being different in at least one of size and shape from said at least two business cards;
each of said at least two business cards being further divided to include a tab portion, separably attached along perforated lines.

34. The system for distributing business cards of claim 33 wherein said tab portion includes a space for providing contact information of a recipient.

35. The system for distributing business cards of claim 34 wherein said contact information is chosen from the group consisting of: a name of a recipient, an address of a recipient, a phone number of a recipient and an email address of a recipient.

36. The system for distributing business cards of claim 34 wherein said tab has a tracking code printed thereon.

37. The system for distributing business cards of claim 33 wherein said additional information relating to a subscribing business is a special offer, said special offer chosen from the group consisting of, a coupon for a free item, a coupon for a percentage discount, a coupon for a dollar value discount, a free gift, a gift certificate and a gift card.

38. The system for distributing business cards of claim 33 wherein said additional information relating to a subscribing business is a map.

39. The system for distributing business cards of claim 33 wherein said identification information is chosen from the group consisting of: a name of said subscribing business, an address of said subscribing business, a phone number of said subscribing business, a web address of said subscribing business and an email address of said subscribing business.

40. The system for distributing business cards of claim 33 further comprising at least one self-adhesive magnetic strip.
